(19) United States
(12) Patent Application Publication
(10) Pub. No.: US 2010/0183137 A1
(43) Pub. Date: Jul. 22, 2010

(54) Phone With Child Mode

(76) Inventor: Karl Allen Dierenbach, Centennial, CO (US)

Correspondence Address: KARL ALLEN DIERENBACH, 7587 SOUTH XANTHIA COURT, CENTENNIAL, CO, 80112, US

(21) Appl. No.: 12/685,047

(22) Filed: Jan. 11, 2010

Related U.S. Application Data
(60) Provisional application No. 61/145,725, filed on Jan. 19, 2009.

(51) Int. Cl. H04M 3/42; H04M 3/00

(52) U.S. Cl. 379/207.02; 455/418

(57) ABSTRACT

A phone is provided that includes a child mode of operation. The child mode may be used when it is desired to give a young child a phone while a call is in progress. While in child mode, buttons of the phone may be deactivated such that the child handling the phone is unable to disconnect or otherwise interfere with the ongoing phone call. In this regard, a user may place the phone into child mode and pass the phone to the child. The child will then be able to talk into the phone and hear the remote party. Pressing buttons on the phone while in child mode may not result in audible tones, which could be distracting and/or annoying to the remote party and/or the child.

### RELATED APPLICATIONS

This application claims priority benefit of U.S. Provisional Application No. 61/145,725, filed Jan. 19, 2009, which is incorporated herein by reference in its entirety.

### BACKGROUND

Oftentimes it may be desirable to allow a very young child to take part in a telephone conversation. The desire may emanate form a remote relative or friend wishing to talk to the child. The desire may emanate from the young child as, for example, a result of seeing an adult using a phone.

### SUMMARY

The present inventor has recognized that talking to a young child (e.g., 1-4 years old) over the phone can be difficult. To avoid the child handling the phone, an adult may hold the phone up to the child's ear or place the phone in speakerphone mode while preventing the child from handling the phone. The adult may do this to prevent the child from purposely or inadvertently pressing one or more buttons on the phone. However, it may be inconvenient for the adult to hold the phone due to other tasks (e.g., driving, carrying objects) that the adult may wish or need to perform while the child is talking on the phone. Additionally, the child may not be satisfied unless he is permitted to handle the phone. An alternative is to give the child the phone, however such conversations may be inhibited by the child pressing one or more buttons on the phone during the phone call. This may result in unwanted tones being generated as various buttons are pressed which may be irritating to other party and/or distracting to the child (e.g., it may distract the child from talking to other party). The pressing of various buttons by the child may result in features of the phone or network being inadvertently engaged, disengaged and/or accessed. Furthermore, activating buttons that result in the visual display changing may also be distracting to the child. Moreover, access to certain features (e.g., pay-per-use features) may result in unexpected and/or unwanted charges. Finally, such actions by the child may lead to unwanted disconnection (hanging up) of the phone.

The present invention provides a phone with a mode of operation where all functions of phone are disabled except for the ability to exit the mode (hereinafter referred to as “child mode”). The ability to exit child mode may be triggered by a very specific action or set of actions that are unlikely to be performed by a child handling the phone. As such, the phone can be handed to a child and the child will not be able to hang-up, access any phone features, or generate distracting tones or other phone responses by pressing buttons. The child may be satisfied because they have independent physical control of the phone and can concentrate on the voice heard through the phone and on the conversation.

To use the child mode, a user may initiate or receive a call and switch the phone to the child mode. The phone call will remain active (as long as other party doesn't hang up) and the phone may be handed to a child. The child may handle, manipulate, examine, listen, speak into, and converse using the phone without distractions from other phone functions and without adversely affecting the phone or the phone call. At any given time, the user can take back the phone. The user may then perform a specific action to exit the child mode (e.g., actuate a specific button sequence, activate a predetermined switch, use a specific verbal command). The user may then continue the use of the phone in a normal manner, including continuing the present phone call.

One aspect of the present invention is in the form of a phone that includes a housing, a plurality of buttons on the housing, and a switch on the housing. The switch may be operable to switch the phone into a child mode. While the phone is in the child mode, a call cannot be disconnected by depressing any of the plurality of buttons. While the phone is in the child mode, the phone may be operable to maintain an in-process call, including maintaining both audio-sending and audio-receiving capabilities.

In an embodiment, the switch may be operable to slide between two positions. The switch may be recessed below a level of the housing surrounding the switch. The phone may be free from audible responses to activation of any of the plurality of buttons when the phone is in the child mode. The switch may be operable to disable all of the plurality of buttons. The switch position may be readable by a controller (e.g., a portion of software of the phone, a portion of electronic hardware of the phone, or a combination of software and hardware) of the phone, and the controller may be operable to disable the plurality of buttons when the switch is in a first position. The switch may be operable to directly disable the plurality of buttons by interrupting a circuit that includes the plurality of buttons.

Another aspect may include a phone comprising a housing, a plurality of buttons on the housing, and a button controller (e.g., the button controller may be in the form of a portion of the software of the phone, a portion of the electronic hardware of the phone, or a combination of software and hardware) operable to control the plurality of buttons. The button controller may be operable to function in a first mode and in a second mode of functionality. The first mode may be a normal operating mode and while in the second mode a call may not be disconnected by inadvertently depressing at least a portion of the plurality of buttons. The button controller may be operable to switch from the first mode to the second mode upon receipt of a second-mode-initiation command from a user. The phone may be operable to maintain an in-process call when the phone is switched between the first and second modes. Both audio-sending and audio-receiving capabilities may be maintained when the button controller is in the second mode.

In an embodiment, the phone may be a cordless phone. In an embodiment, the phone may be a wireless phone. The wireless phone may be a cellular phone.

In an embodiment, while the phone is in the second mode, all of the plurality of buttons may be disabled except for the ability to receive a second-mode-initiation command from a user to switch from the second mode to the first mode. The second-mode-initiation command may be entered via a menu system of the phone. The second-mode-initiation command may be entered by pressing one or more of the plurality of buttons in a unique, predetermined sequence. The second-mode-initiation command may be entered by simultaneously pressing two or more predetermined buttons for a predetermined duration.

The button controller may be operable to switch from the second mode to the first mode upon receipt of a first-mode-initiation command from a user. The first-mode-initiation command may be the same as the second-mode-initiation command. The first-mode-initiation command may be entered by pressing one or more predetermined buttons in a unique sequence. The first-mode-initiation command may be entered by pressing a predetermined one of the plurality of buttons for a predetermined duration. The first-mode-initiation command may be entered by simultaneously pressing a predetermined plurality of the plurality of buttons for a predetermined duration.

When in the second mode, the phone may be free from audible responses to activation of any of the plurality of buttons.

Another aspect is embodied by a method of using a phone that includes connecting to a phone call with the phone, then activating a child mode of operation of the phone, and then deactivating the child mode. While in the child mode, the phone call may be maintained and all buttons on the phone may be disabled except for the ability to exit the child mode. The phone call may be maintained throughout the activating and deactivating steps.

In an embodiment, the method may further comprise transferring, after the activating step and prior to the deactivating step, the phone to a child while the phone is in the child mode. The phone call may be maintained throughout the transferring step. In an embodiment, the method may further comprise retrieving, after the transferring step and prior to the deactivating step, the phone from the child, where the phone call is maintained throughout the retrieving step.

The various features, arrangements and embodiments discussed above in relation to each aforementioned aspect may be utilized by any of the aforementioned aspects. Additional aspects and corresponding advantages will be apparent to those skilled in the art upon consideration of the further description that follows.

### BRIEF DESCRIPTION OF THE DRAWINGS

FIG. 1 is an illustration of a phone with a switch for activating and deactivating child mode.

FIG. 2 is an illustration of a phone with the ability to activate and deactivate child mode based on inputs from a user.

FIG. 3 is a flow diagram of a method of using a phone that includes a child mode of operation.

### DETAILED DESCRIPTION

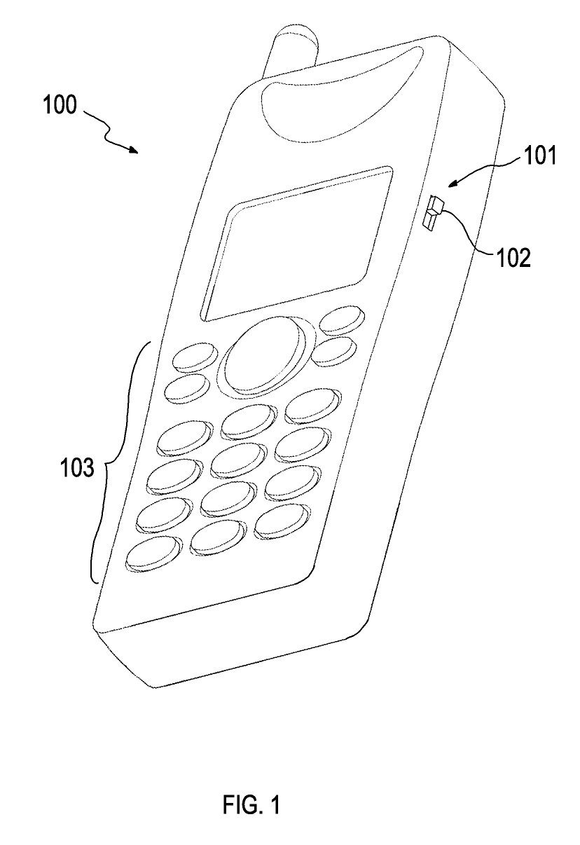

FIG. 1 is an illustration of an embodiment of a phone 100 that includes a switch 101 that may be used to enter and/or exit a child mode of operation of the phone 100. The switch 101 may be movable between a first position and a second position. The phone 100 may be a cellular phone or cordless phone or personal digital assistant (PDA) with cellular phone capabilities. The switch 101 may be any appropriate type of switch. The switch 101 may be configured such that it may be difficult for a young child to operate. For example, a slide portion 102 of the switch 101 may be recessed such that direct pressure on the phone 100 in the area of the switch 101 is required to change the position of the switch 101.

Functionally, when the switch 101 is in the first position, the phone 100 may be used as normal. When the switch 101 is actuated into the second position, child mode may be activated. The phone 100 may be configured such that it remains in child mode until the switch is returned to the first position or until a predetermined amount of time has elapsed since child mode was entered. The details of the functionality of the phone 100 while in child mode are discussed below. The switch 101 may be interconnected to the phone 100 such that placing the switch 101 into the second position disconnects or otherwise renders remaining buttons 103 of the phone 100 non-functional. For example, the switch 101 may ground an internal component of the phone 100 such that the remaining buttons 103 are non-functioning. In another implementation, the position of the switch 101 may be an input into a button controller or other logic component of the phone 100, and the button controller or other logic component may place the phone 100 into child mode.

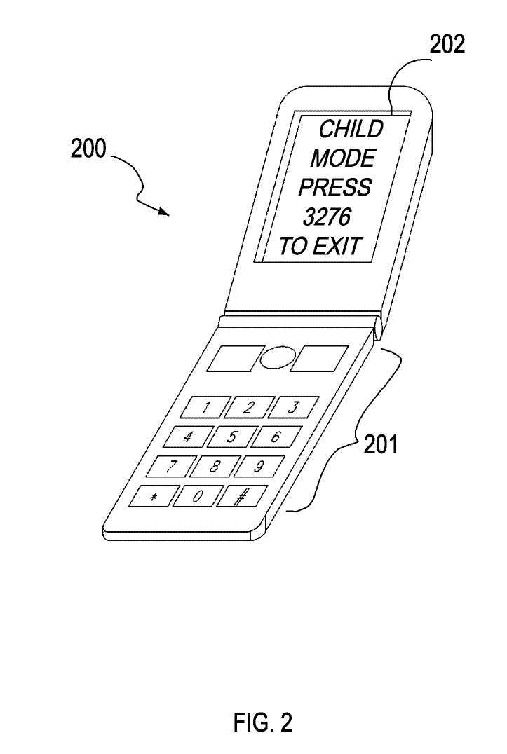

FIG. 2 is an illustration of an embodiment of a phone 200 that does not include a separate and dedicated switch that may be used to enter or exit the child mode of operation. In the phone 200 of FIG. 2, child mode may be activated and deactivated through actuation of existing buttons 201 and/or through voice commands. For example, child mode may be activated by paging through and selecting an item of a display and/or an on-screen menu system of the phone 200. In another example, child mode may be activated via an extended key press or simultaneous pressing of multiple keys. In another example, child mode may be activated by entering a specific sequence of buttons. In still another example, child mode may be entered via a voice command. In another example, the user may be able to configure the phone 200 to enter into child mode in a user-selected manner. Any appropriate method of activating a feature of the phone 200 may be used to activate child mode.

To deactivate child mode, the user may press a predetermined sequence of buttons. In another example, child mode may be deactivated via an extended key press or simultaneous pressing of multiple keys. In still another example, child mode may be deactivated via a voice command.

Operation of the phone 200 while in child mode will now be described. As appropriate, the description of the child mode of phone 200 will apply to the operation of the phone 100 while in child mode. While in child mode, phone 200 may be operable to maintain an active call including both incoming audio and outgoing audio. Any pressing of any of the buttons 201 will not result in an audible signal being heard by either party to the call (e.g., the child using the phone 200 in child mode or the person on the other end of the call) while the phone 200 is in child mode. Furthermore, except as described below, any pressing of any of the buttons 201 may not result in a visual change to the phone 200 (e.g., a display 202 or screen may not change in response to the pressing of any button and any lighting of buttons 201 may not change). While in child mode the phone 200 may only be capable of the following functions: receiving and playing incoming communications (e.g., producing the sound of the voice of the remote party to the call); communicating outgoing audio (e.g., sending the voice of the child using the phone 200 in child mode to the party remote to the call); ending a phone call when the phone call is terminated by the remote party; and exiting child mode.

While in child mode, the display 202 may display an indicator that it is in child mode (e.g., text and/or an icon). As illustrated in FIG. 2, the display 202 may also display instructions as to how to exit child mode. This may be beneficial since the child may be too young to be able to read and follow such instructions. In another implementation, the display 202 may be dark or display a fixed image while the phone 200 is in child mode.

In one embodiment, the display 202 may only change while in child mode in response to a correctly entered key press. For example, as shown in FIG. 2, a user must press 3276 to exit child mode. Of course, any appropriate code (e.g., of any appropriate length, alphanumeric) could be substituted for the illustrated 3276. In such an embodiment, the phone 200 may react when the “3” key is pressed by highlighting or changing the “3” on the display 202. If the next key pressed is not the “2” key, the phone 200 may un-highlight the “3” on the display 202. If the next key pressed is the “2” key, the phone may react by highlighting or changing the “2” on the display 202. In this manner, a user may receive feedback that they are correctly performing the procedure of exiting child mode, yet the feedback may be subtle enough not to distract a child using the phone 200 in child mode who has inadvertently pressed a key of the exit sequence.

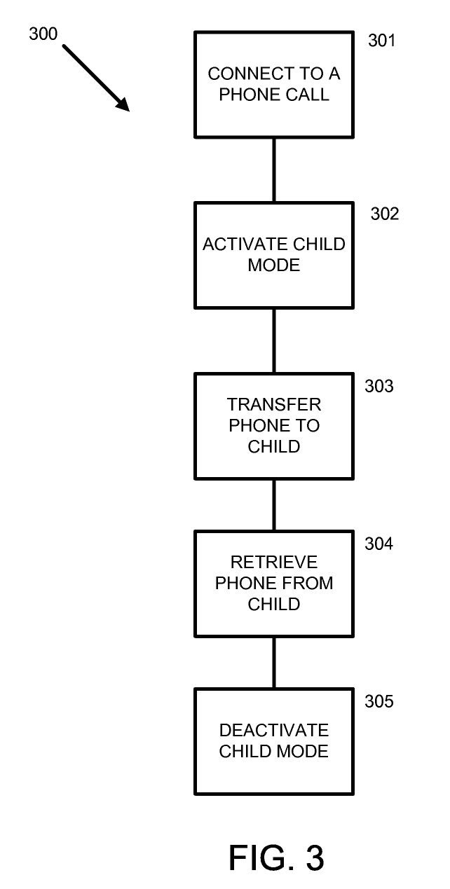

FIG. 3 is a flow diagram 300 of a method of using a phone (e.g., a cell phone or a wireless phone) that includes a child mode of operation. A first step 301 in the method may be for a user to connect to a phone call. This may be achieved in any appropriate way including answering an incoming call or initiating an outgoing call. The user may then converse with the remote party on the other end of the call. At a point during the phone call, the user may wish to hand the phone to a child. Prior to doing so, the user may perform the step 302 of activating child mode on the phone. The user may activate child mode by pressing a specific button, pressing a series of buttons, speaking a specific command (to activate the child mode using a voice command), activating a menu command, or by any other appropriate means. The next step 303 may be to transfer the phone to the child. The child may then talk into the phone and hear the party on the other end of the connection. While in child mode, the child will not be able to disconnect or otherwise interfere with the connection. Where the phone is a “flip-phone” such a shown in FIG. 2, child mode may be configured such that closing the phone does not interfere with the connection (e.g., closing the phone will not result in hanging up or otherwise disconnecting the remote party). While in child mode, the remote party may disconnect the call. Once disconnected in such a manner, the phone in child mode may remain in child mode until child mode is deactivated. Alternatively, the phone may remain in child mode for a set period of time and then automatically exit child mode.

A next step 304 may be for the user to retrieve the phone form the child. This may be followed by the step 305 of the user deactivating child mode. Child mode may be deactivated by, for example, pressing a specific button (e.g. for a predetermined extended period of time), pressing a series of buttons (e.g., a specific code), speaking a specific command (to deactivate the child mode using a voice command), or by any other appropriate means. Once child mode has been deactivated, the user may continue the conversation with the remote party or perform any other task that may be performed with the phone.

Activation of child mode has been described herein in the context of allowing a child to take part in a phone conversation without the potential problem of the child accidently disconnecting or otherwise interfering with the use of the phone. Child mode may also be used when a phone call is not active. For example, a child may desire to handle a phone (e.g., after seeing an adult use the phone) and a user may wish to let the child handle the phone. In such a situation, child mode may be activated such that the buttons will be inactive or of limited functionality. Such a child mode may be configured such that while in child mode, the phone may not initiate an outgoing call. Other functions, such as accessing menu commands or changing phone settings, may also be disabled. The phone may retain some limited functions (e.g., such as audible tone generation or displaying numbers on a display when a numbered button is pressed) that may be entertaining and/or educational to the child.

Additional modifications and extensions to the embodiments described herein will be apparent to those skilled in the art. Such modifications and extensions are intended to be within the scope of the present invention as defined by the claims that follow.

What is claimed is:

1. A phone comprising:
a housing;
a plurality of buttons on said housing; and
a switch on said housing, wherein said switch is operable to switch said phone into a child mode, wherein in said child mode a call cannot be disconnected by depressing any of said plurality of buttons, wherein said phone is operable to maintain an in-process call when said phone is in said child mode, wherein both audio-sending and audio-receiving capabilities are maintained when said phone is in said child mode.

2. The phone of claim 1, wherein said switch is operable to slide between two positions.

3. The phone of claim 1, wherein said switch is recessed below a level of said housing surrounding said switch.

4. The phone of claim 1, wherein said switch is operable to disable all of said plurality of buttons

5. The phone of claim 4, wherein said switch position is readable by a controller of said phone, wherein said controller is operable to disable said plurality of buttons when said switch is in a first position.

6. The phone of claim 4, wherein said switch is operable to directly disable said plurality of buttons by interrupting a circuit that includes said plurality of buttons.

7. The phone of claim 1, wherein said phone is free from audible responses to activation of any of said plurality of buttons when said phone is in said child mode.

8. A phone comprising:
a housing;
a plurality of buttons on said housing; and
a button controller operable to control said plurality of buttons, wherein said button controller is operable to function in a first mode and a second mode of functionality, wherein said first mode is a normal operating mode, wherein in said second mode a call cannot be disconnected by inadvertently depressing at least a portion of said plurality of buttons, wherein said button controller is operable to switch from said first mode to said second mode upon receipt of a second-mode-initiation command from a user, wherein said phone is operable to maintain an in-process call when said phone is switched between said first and second modes, wherein both audio-sending and audio-receiving capabilities are maintained when said button controller is in said second mode.

9. The phone of claim 8, wherein said phone is a cordless phone.

10. The phone of claim 8, wherein said phone is a wireless phone.

11. The phone of claim 10, wherein said phone is a cellular phone.

12. The phone of claim 1, wherein in said second mode all of said plurality of buttons are disabled except for the ability to receive a second-mode-initiation command from a user to switch from said second mode to said first mode.

13. The phone of claim 12, wherein said second-mode-initiation command is entered via a menu system of said phone.

14. The phone of claim 12, wherein said second-mode-initiation command is entered by pressing one or more of said plurality of buttons in a unique sequence.

15. The phone of claim 12, wherein said second-mode-initiation command is entered by simultaneously pressing two or more of said plurality of buttons for a predetermined duration.

16. The phone of claim 12, wherein said button controller is operable to switch from said second mode to said first mode upon receipt of a first-mode-initiation command from a user.

17. The phone of claim 8, wherein when in said second mode, said phone is free from audible responses to activation of any of said plurality of buttons.

18. A method of using a phone comprising:
connecting to a phone call with said phone;
activating, after said connecting step, a child mode of operation of said phone wherein in said child mode said phone call is maintained and all buttons on said phone are disabled except for the ability to exit said child mode; and
deactivating, after said activating step, said child mode, wherein said phone call is maintained throughout said activating and deactivating steps.

19. The method of claim 18, further comprising transferring, after said activating step and prior to said deactivating step, said phone to a child while said phone is in said child mode, wherein said phone call is maintained throughout said transferring step.

20. The method of claim 19, further comprising retrieving, after said transferring step and prior to said deactivating step, said phone from said child, wherein said phone call is maintained throughout said retrieving step.
